(19) United States
(12) Patent Application Publication
(10) Pub. No.: US 2012/0098939 A1
(43) Pub. Date: Apr. 26, 2012

(54) IMAGE PROCESSING APPARATUS AND METHOD, AND PROGRAM

(76) Inventor: Yasutaka HIRASAWA, Tokyo (JP)

(21) Appl. No.: 13/271,524

(22) Filed: Oct. 12, 2011

(30) Foreign Application Priority Data
Oct. 21, 2010 (JP) P2010-236156

(51) Int. Cl. H04N 13/02

(52) U.S. Cl. 348/47; 348/E13.074

(57) ABSTRACT

Disclosed is an image processing apparatus including: an imaging section which images a first image and a second image; a one-dimensional arrangement value calculating section which adds up pixel values of horizontal pixels in respective lines in the first image and the second image to calculate a first one-dimensional arrangement value and a second one-dimensional arrangement value; an adjustment parameter calculating section which calculates an adjustment parameter based on a difference between the first one-dimensional arrangement value and the second one-dimensional arrangement value; and a correction control section which controls correction of a magnification of the first image or the second image on the basis of the adjustment parameter.

### BACKGROUND

The present disclosure relates to an image processing apparatus, an image processing method and a program, and more particularly, to an image processing apparatus, an image processing method and a program which can correct deviation of field angles of left and right images for a stereoscopic image, that is, deviation of zoom magnifications.

Techniques which employ a stereoscopic image process have become widespread.

The stereoscopic image process refers to a process in which the same object is imaged by two cameras which are disposed on the left and right sides and is recognized as a three-dimensional space using parallax of two imaged images on the left and right sides.

In the stereoscopic image process, it is assumed that the left and right cameras are disposed at the same height and perform imaging at the same field angle (zoom magnification).

However, in reality, the field angles (zoom magnifications) of two images on the left and right sides may deviate from each other due to physical factors such as the arrangement of the two cameras. In this case, even though stereovision is formed, the processing result may cause a sense of discomfort, which may obstruct the recognition as the three-dimensional space.

In this regard, in order to correct deviation of the field angles of two images for stereovision, there has been proposed a technique in which zoom amounts are obtained from respective cameras, and deviation of the field angles is calculated from the obtained zoom amounts to correct the field angle deviation (refer to Japanese Unexamined Patent Application Publication No. 2002-223384).

Further, there has been proposed a technique in which points corresponding to particular points in four corners of a left image are detected from a right image, and deviation of field angles is calculated on the basis of difference between a horizontal distance between two upper points and a horizontal distance between two lower points for correction (refer to Japanese Unexamined Patent Application Publication No. 2006-157432).

### SUMMARY

However, in the technique of Japanese Unexamined Patent Application Publication No. 2002-223384, since the zoom amounts are obtained from the cameras, it is necessary to perform the process at the time of imaging, or to assign information about the zoom amounts to images. Further, the field angle deviation may occur as the focal positions are different from each other on the left and right sides, in addition to the zoom difference, but the technique of Japanese Unexamined Patent Application Publication No. 2002-223384 have difficulties in dealing with this problem.

Further, in the technique of Japanese Unexamined Patent Application Publication No. 2006-157432, since the deviation amount of field angles is calculated only with analysis of images, the particular information as in Japanese Unexamined Patent Application Publication No. 2002-223384 is unnecessary. However, since the accuracy of the result depends upon the detection accuracy of the corresponding points, there is a high possibility of error occurrence.

Accordingly, it is desirable to provide a technique which is capable of calculating a shift amount in any one of left and right images for a stereoscopic image and correcting deviation of field angles (zoom magnifications) of the left and right images on the basis of shift amount with high accuracy.

According to an embodiment of the present disclosure, there is provided an image processing apparatus including: an imaging section which images a first image and a second image; a one-dimensional arrangement value calculating section which adds up pixel values of horizontal pixels in respective lines in the first image and the second image to calculate a first one-dimensional arrangement value and a second one-dimensional arrangement value; an adjustment parameter calculating section which calculates an adjustment parameter based on a difference between the first one-dimensional arrangement value and the second one-dimensional arrangement value; and a correction control section which controls correction of a magnification of the first image or the second image on the basis of the adjustment parameter.

The adjustment parameter calculating section may calculate an adjustment parameter for matching the first one-dimensional arrangement value and the second one-dimensional arrangement value on the basis of the difference between the first one-dimensional arrangement value and the second one-dimensional arrangement value.

The adjustment parameter calculating section may include: a difference absolute value map generating section which generates a difference absolute value map including an absolute value of the difference between the first one-dimensional arrangement value and the second one-dimensional arrangement value; a cost calculating section which calculates a cost between respective nodes in the difference absolute value map when a path from one end portion of the difference absolute value map to the other end portion thereof is formed; and a shift amount calculating section which calculates a shift amount from a path in which the cost calculated by the cost calculating section is the minimum, as the adjustment parameter.

The difference absolute value map generating section may generate a first difference absolute value map including a difference absolute value between respective elements of the first one-dimensional arrangement value and the second one-dimensional arrangement value when the respective elements of the first one-dimensional arrangement value are used as a reference, and a second difference absolute value map including a difference absolute value between the respective elements of the first one-dimensional arrangement value and the second one-dimensional arrangement value when the respective elements of the second one-dimensional arrangement value are used as a reference.

The correction control section may control the correction of the magnification of the first image or the second image, on the basis of an inclination of a shift amount in which the inclination is calculated as a negative value, among an inclination of a shift amount based on the first difference absolute value map and an inclination of a shift amount based on the second difference absolute value map.

The correction control section may calculate the inclination of the shift amount on the basis of a maximum value or a minimum value of the shift amount which is the adjustment parameter or on the basis of a least square method, and may control the correction of the magnification of the first image or the second image on the basis of the inclination.

The cost calculating section may calculate the cost between the respective nodes in the difference absolute value map when the path from one end portion of the difference absolute value map to the other end portion thereof is formed, by dynamic programming.

The adjustment parameter calculating section may include: a storing section which stores information on the shift amounts according to a plurality of correction amounts for the first one-dimensional arrangement value or the second one-dimensional arrangement value; a shifting section which shifts the first one-dimensional arrangement value or the second one-dimensional arrangement value on the basis of the shift amount for each correction amount stored in the storing section; and an evaluation value calculating section which calculates an evaluation value including the sum of the difference absolute values of the respective elements of the first one-dimensional arrangement value and the second one-dimensional arrangement value shifted by the shifting section as the adjustment parameter, and the correction control section may include a correction amount determining section which determines a correction amount in which the evaluation value which is the adjustment parameter is the minimum, and may control the correction of the magnification of the first image or the second image with the correction amount determined by the correction amount determining section.

According to another embodiment of the present disclosure, there is provided an image processing method in an image processing apparatus including an imaging section which images a first image and a second image; a one-dimensional arrangement value calculating section which adds up pixel values of horizontal pixels in respective lines in the first image and the second image to calculate a first one-dimensional arrangement value and a second one-dimensional arrangement value; an adjustment parameter calculating section which calculates an adjustment parameter based on a difference between the first one-dimensional arrangement value and the second one-dimensional arrangement value; and a correction control section which controls correction of a magnification of the first image or the second image on the basis of the adjustment parameter, the method including: imaging the first image and the second image, by the imaging section; adding up the pixel values of the horizontal pixels in the respective lines in the first image and the second image to calculate the first one-dimensional arrangement value and the second one-dimensional arrangement value, by the one-dimensional arrangement value calculating section; calculating the adjustment parameter based on the difference between the first one-dimensional arrangement value and the second one-dimensional arrangement value, by the adjustment parameter calculating section; and controlling the correction of the magnification of the first image or the second image on the basis of the adjustment parameter, by the correction control section.

According to still another embodiment of the present disclosure, there is provided a program which causes a computer which controls an image processing apparatus including an imaging section which images a first image and a second image; a one-dimensional arrangement value calculating section which adds up pixel values of horizontal pixels in respective lines in the first image and the second image to calculate a first one-dimensional arrangement value and a second one-dimensional arrangement value; an adjustment parameter calculating section which calculates an adjustment parameter based on a difference between the first one-dimensional arrangement value and the second one-dimensional arrangement value; and a correction control section which controls correction of a magnification of the first image or the second image on the basis of the adjustment parameter, to execute a routine including: imaging the first image and the second image, by the imaging section; adding up the pixel values of the horizontal pixels in the respective lines in the first image and the second image to calculate the first one-dimensional arrangement value and the second one-dimensional arrangement value, by the one-dimensional arrangement value calculating section; calculating the adjustment parameter based on the difference between the first one-dimensional arrangement value and the second one-dimensional arrangement value, by the adjustment parameter calculating section; and controlling the correction of the magnification of the first image or the second image on the basis of the adjustment parameter, by the correction control section.

According to the above-described embodiment of the present disclosure, the first image and the second image are imaged; the pixel values of the horizontal pixels in the respective lines in the first image and the second image are added up to calculate the first one-dimensional arrangement value and the second one-dimensional arrangement value; the adjustment parameter is calculated on the basis of a difference between the first one-dimensional arrangement value and the second one-dimensional arrangement value; and the correction of the magnification of the first image or the second image is controlled on the basis of the adjustment parameter.

The image processing apparatus according to the embodiment of the present disclosure may be an individual apparatus, or may be a block which performs image processing.

According to the above-described embodiments of the present disclosure, it is possible to correct deviation of field angles of left and right images for a stereoscopic image, that is, deviation of zoom magnifications.

### BRIEF DESCRIPTION OF THE DRAWINGS

FIG. 1 is a block diagram illustrating a configuration example of an embodiment of a stereoscopic image correcting apparatus according to the present disclosure;

FIG. 2 is a flowchart illustrating a stereoscopic image correcting process in the stereoscopic image correcting apparatus in FIG. 1;

FIG. 3 is a diagram illustrating an image for stereovision;

FIG. 4 is a diagram illustrating a one-dimensional arrangement value including an accumulated value of pixel values of a line unit in a horizontal direction in an image for stereovision;

FIG. 5 is a diagram illustrating a one-dimensional arrangement value including an accumulated value of pixel values of a line unit in a horizontal direction in an image for stereovision;

FIG. 6 is a diagram illustrating a difference absolute value map of a one-dimensional arrangement value in the stereoscopic image correcting apparatus in FIG. 1;

FIG. 7 is a flowchart illustrating a shift amount calculating process in the stereoscopic image correcting apparatus in FIG. 1;

FIG. 8 is a diagram illustrating a cost calculating method in the shift amount calculating process in the stereoscopic image correcting apparatus in FIG. 1;

FIG. 9 is a diagram illustrating an example of cost calculation and shift amount calculation in the shift amount calculating process in the stereoscopic image correcting apparatus in FIG. 1;

FIG. 10 is a diagram illustrating an example of a shift amount;

FIG. 11 is a diagram illustrating a shift amount generated by deviation of field angles;

FIG. 12 is a diagram illustrating a correcting method based on an inclination of a shift amount generated by deviation of field angles, with reference to one image among images for stereovision;

FIG. 13 is a diagram illustrating a correcting method based on an inclination of a shift amount generated by deviation of field angles, with reference to the other image among the images for stereovision;

FIG. 14 is a diagram illustrating a case where imaging positions of imaging sections for images for stereovision are vertically deviated;

FIG. 15 is a diagram illustrating a correcting method based on an inclination of a shift amount generated in a case where imaging positions of imaging sections for images for stereovision are vertically deviated and field angles are deviated;

FIG. 16 is a block diagram illustrating a configuration example of another embodiment of a stereoscopic image correcting apparatus according to the present disclosure;

FIG. 17 is a diagram illustrating an inclination of a shift amount set according to a deviation amount of field angles of images for stereovision;

FIG. 18 is a flowchart illustrating a stereoscopic image correcting process in the stereoscopic image correcting apparatus in FIG. 16; and

FIG. 19 is a diagram illustrating a configuration example of a general-purpose personal computer.

### DETAILED DESCRIPTION OF EMBODIMENTS

Hereinafter, embodiments according to the present disclosure will be described. Description will be made in the following order.

1. First embodiment (Example in which a shift amount is calculated and field angle deviation is corrected)

2. Second embodiment (Example in which field angle deviation is corrected in a case where a shift amount is calculated in advance)

### 1. First Embodiment

### Configuration Example of Stereoscopic Image Correcting Apparatus

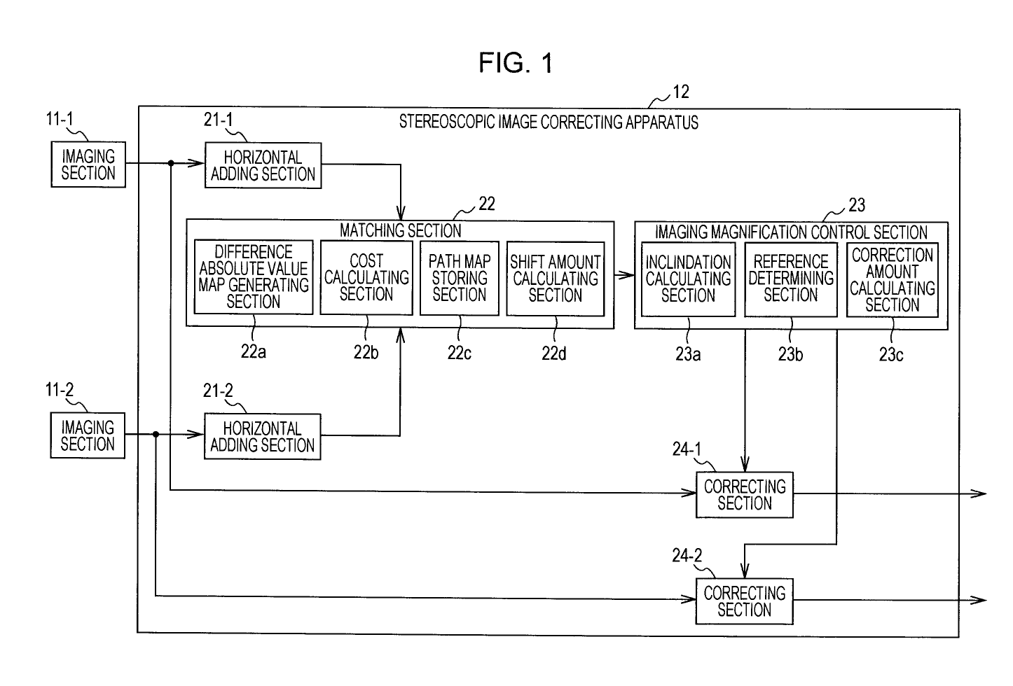

FIG. 1 is a diagram illustrating a configuration example of an embodiment of hardware of a stereoscopic image correcting apparatus according to the present disclosure. A stereoscopic image correcting apparatus 12 shown in FIG. 1 corrects deviation of field angles (zoom magnifications) of two input images, which form a stereoscopic image, which are imaged by imaging sections 11-1 and 11-2, for output.

More specifically, the stereoscopic image correcting apparatus 12 uses one image as a reference image, among two imaged images input by the imaging sections 11-1 and 11-2 which form the stereoscopic image. The stereoscopic image correcting apparatus 12 enlarges or reduces the other image, and aligns the field angles of two stereoscopic images, to thereby correct deviation of the field angles. Here, the “field angle” refers to an angle indicating a range where an image is taken by an imaging device, in the image imaged by the imaging section 11-1 or 11-2. Accordingly, if the field angle is large, the imaging range is enlarged, and adversely if the field angle is small, the imaging range is narrowed. It can be said that this is the same as the relationship that if the zoom magnifications of the imaging sections 11-1 and 11-2 are increased, the imaging range is narrowed, and if the zoom magnifications are decreased, the imaging range is enlarged. Thus, hereinafter, the field angle and the zoom magnification are used as the same parameters which adjust the imaging range. Here, a parameter for controlling the field angle is an angle, and a parameter for controlling the zoom magnification is a magnification, and thus, the parameters themselves are different from each other.

The imaging sections 11-1 and 11-2 include an imaging device, and supply imaged images to the stereoscopic image correcting apparatus 12 as image data, respectively. The imaging sections 11-1 and 11-2 are disposed so that two images respectively imaged by the imaging sections 11-1 and 11-2 form a stereoscopic image.

The stereoscopic image correcting apparatus 12 includes horizontal adding sections 21-1 and 21-2, a matching section 22, an imaging magnification control section 23, and correcting sections 24-1 and 24-2.

The horizontal adding sections 21-1 and 21-2 add up pixel values of pixels which are aligned with the images imaged by the imaging sections 11-1 and 11-2 by a line unit in a horizontal direction to generate one-dimensional arrangement values, and supply the result to the matching section 22, respectively.

The matching section 22 calculates, on the basis of the one-dimensional arrangement values which are respectively supplied from the horizontal adding sections 21-1 and 21-2, a shift amount necessary for matching any one-dimensional arrangement value with the other one-dimensional arrangement value which is a reference, and supplies the result to the imaging magnification control section 23 as an adjustment parameter.

More specifically, the matching section 22 includes a difference absolute value map generating section 22a, a cost calculating section 22b, a path map storing section 22c, and a shift amount calculating section 22d. The difference absolute value map generating section 22a generates a map including round robin difference absolute values for respective elements of the one-dimensional arrangement value from each of the horizontal adding sections 21-1 and 21-2. The cost calculating section 22b calculates a cost generated between nodes adjacent in a direction from one end of the difference absolute value map to the other end thereof. Further, the cost calculating section 22b selects a space between nodes where the cost is the minimum as a path, and repeats a process of using the calculation result of the minimum cost between the nodes selected as the path for cost calculation between sequentially adjacent nodes. Here, the cost calculating section 22b stores information about the space between the nodes selected as the path in the path map storing section 22c. The shift amount calculating section 22d calculates a path route which connects paths from nodes in which a final total cost is the minimum, among paths stored in the path map storing section 22c, calculates a shift amount of each node which forms the pass route from the pass route, and then supplies the result to the imaging magnification control section 23 as the adjustment parameter. The matching section 22 calculates two types of shift amounts with reference to the respective two one-dimensional arrangement values, and supplies the results to the imaging magnification control section 23 as the adjustment parameters, respectively.

The imaging magnification control section 23 calculates a correction amount according to any pixel position of the imaging sections 11-1 and 11-2, on the basis of information about two types of shift amounts which are the adjustment parameters supplied by the matching section 22, and performs correction by any corresponding correcting section 24-1 or 24-2. More specifically, the imaging magnification control section 23 includes an inclination calculating section 23a, a reference determining section 23b and a correction amount calculating section 23c. The inclination calculating section 23a calculates an inclination by dividing a difference between the maximum value and the minimum value by the number of samples, or by a least square method, for each of the two types of shift amounts. The reference determining section 23b determines a predetermined inclination among the calculated two types of inclinations as a reference for calculating the correction amount, and determines a corresponding image among the images imaged by the imaging sections 11-1 and 11-2 as a reference. The correction amount calculating section 23c calculates a correction amount for each pixel position using the calculated inclination, and controls correction of an image which is not the reference, for any one of the correcting sections 24-1 and 24-2.

### [Stereoscopic Image Correcting Process in Stereoscopic Image Correcting Apparatus in FIG. 1]

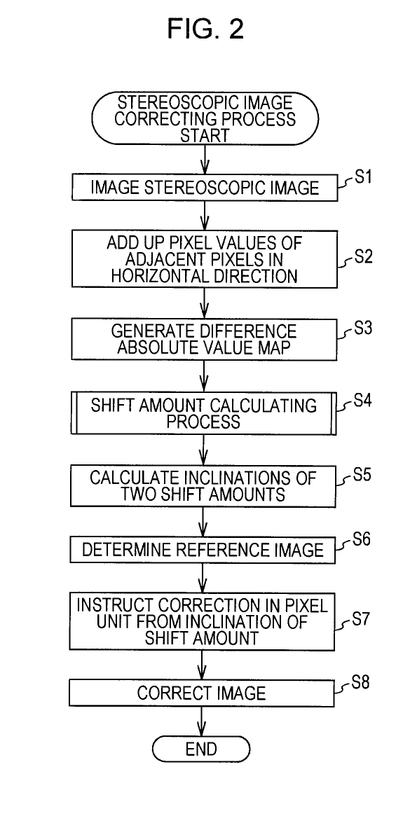

Next, the stereoscopic image correcting process in the stereoscopic image correcting apparatus 12 in FIG. 1 will be described with reference to a flowchart in FIG. 2.

In step S1, the imaging sections 11-1 and 11-2 respectively image images which form a stereoscopic image, and supply the imaged images to the horizontal adding sections 21-1 and 21-2 of the stereoscopic image correcting apparatus 12.

In step S2, the horizontal adding sections 21-1 and 21-2 respectively add up pixel values of pixels which form the supplied stereoscopic images by the line unit, and generate one-dimensional arrangement values including added values in respective lines.

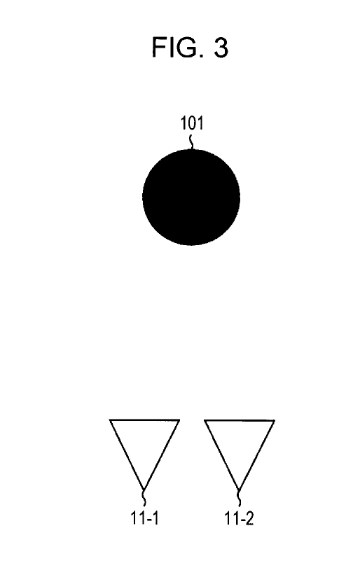

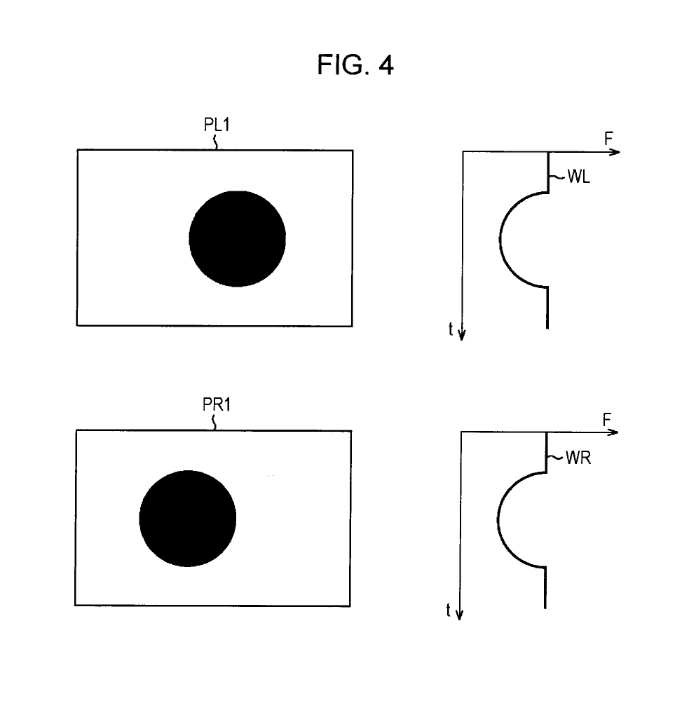

That is, for example, when the imaging sections 11-1 and 11-2 image a spherical object 101 as shown in FIG. 3, the imaged images become images PL1 and PR1 as shown in a left section of FIG. 4, respectively. The black spherical object in the images PL1 and PR1 is the object 101. White portions in the images have a pixel value of 1, and the black portions have a pixel value of 0. The horizontal adding sections 21-1 and 21-2 respectively add up pixel values of pixels which are horizontally adjacent by the line unit in the images PL1 and PR1 to generate one-dimensional arrangement values. For example, when a pixel value of a pixel (x, y) is I(x, y) (x is a horizontal coordinate in the image, and y is a vertical coordinate in the image), a sample value F(t) in the t-th line is expressed as follows.

F(t)=I(0,t)+I(1,t)+ . . . +I(W−1,t)

Here, W is the number of horizontal pixels in the image. Further, the relationship with the sample value F(t) for the line number t of the images PL1 and PR1 becomes a relationship indicated by waveforms WL and WR in a right section of FIG. 4. That is, in a vertical position where the object 101 in each of the images PL1 and PR1 is disposed, the sample value F(t) becomes small, and the sample value F(t) becomes large since pixel values of all the pixels are added by as much as the number of pixels in a range other than the vertical position, which becomes the same value. Since the sample value F(t) corresponds to discrete variations, the waveforms WL and WR are waveforms obtained by connecting the discrete variations of the sample value F(t).

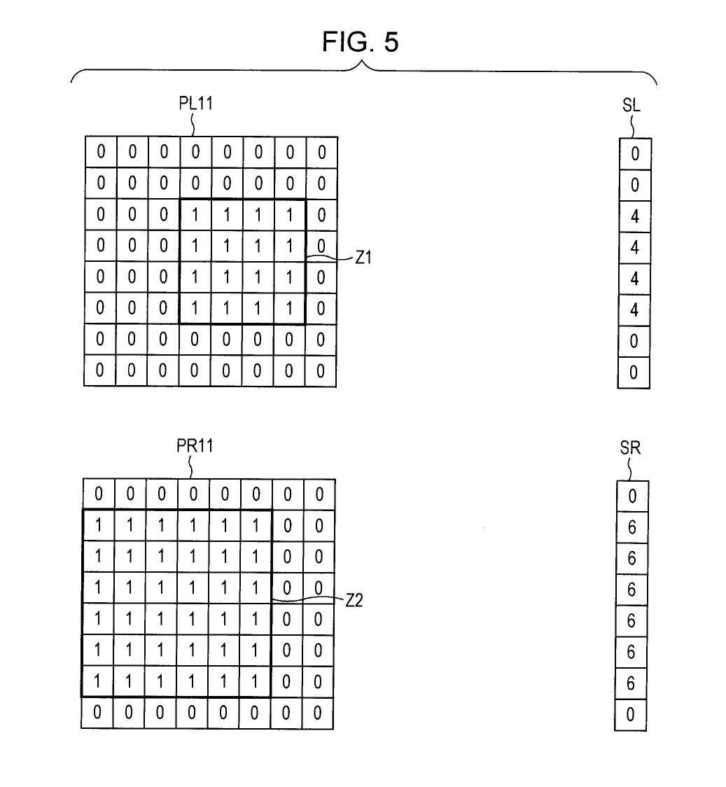

Further, the one-dimensional arrangement value is an arrangement value including elements of the same number as the number of lines (the number of pixels in the vertical direction) which forms the image, in the sample value F(t) as the discrete variations. That is, for example, in a case where pixel value maps of images which form a stereoscopic image when a stereoscopic object of a square shape is an object are pixel value maps PL11 and PR11 shown in a left section of FIG. 5, one-dimensional arrangement values SL and SR are as shown in a right section of FIG. 5.

Here, each of the pixel value maps PL11 and PR11 in FIG. 5 is a pixel value map of an image of 8 pixels×8 pixels, in which a region of the object has a pixel value of 1 and the other region has a pixel value of 0. Accordingly, in the pixel value map PL11 of the image imaged by the imaging section 11-1, a pixel value in a range of 4 pixels×4 pixels surrounded by a region Z1 is 1, which forms the object. Further, in the pixel value map PL12 of the image imaged by the imaging section 11-2, a pixel value in a range of 6 pixels×6 pixels surrounded by a region Z2 is 1, which forms the object.

In the case of the image PL11, since the pixel values of the first, second, seventh and eighth lines from the top are all zero, the first, second, seventh and eighth elements of the one-dimensional arrangement value SL from the top become “0”. Further, in the third to sixth lines of the one-dimensional arrangement value SL from the top, since the pixel values of the total four pixels of the fourth pixel to the seventh pixel from the left are “1” and the pixel values of the other pixels are zero, the third to sixth elements of the one-dimensional arrangement value SL from the top become “4”.

Further, similarly, in the case of the image PR11, since the pixel values of the first and eighth lines from the top are all zero, the first and eighth elements of the one-dimensional arrangement value SR from the top become “0”. Further, in the second to seventh lines of the one-dimensional arrangement value SR from the top, since the pixel values of the total six pixels of the first pixel to the sixth pixel from the left are “1” and the pixel values of the other pixels are zero, the second to seventh elements of the one-dimensional arrangement value SR from the top become “6”.

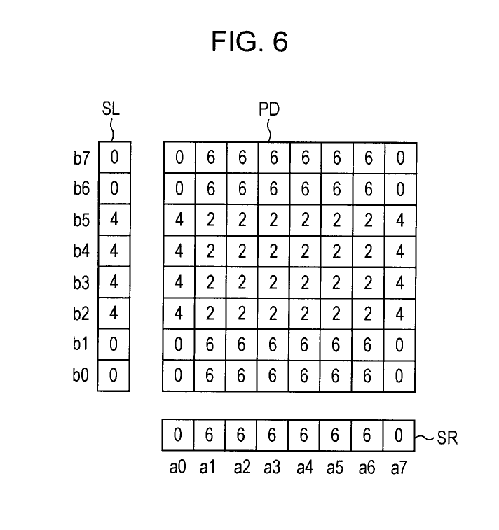

In step S3, the matching section 22 controls the difference absolute value map generating section 22a and generates a difference absolute value map on the basis of the obtained two one-dimensional arrangement values. The difference absolute value map becomes a difference absolute value map PD in FIG. 6, for example, in the case of two one-dimensional arrangement values SR and SL. For example, the elements of the one-dimensional arrangement values SR and SL are expressed as (a0, a1, . . . , a7) and (b0, b1, . . . , b7). Further, respective nodes in the difference absolute value map PD are expressed as PD(ar, bs) (r=0 to 7, s=0 to 7) corresponding to arrangement of the elements of the one-dimensional arrangement values SR and SL in FIG. 6. In this case, a node PD (a0, b0) in the difference absolute value map PD is |a0−b0|, and becomes 0 (=|0−0|) in the case of FIG. 6. Further, a node PD (a1, b5) in the difference absolute value map PD is |a1−b5|, and becomes 2 (=|6−4|) in the case of FIG. 6. In this way, the difference absolute value map is a map in which round robin difference absolute values between respective elements of two one-dimensional arrangement values are used as respective nodes.

In step S4, the matching section 22 performs a shift amount calculating process, and calculates, on the basis of two one-dimensional arrangement values, shift amounts of a pixel unit calculated using each one-dimensional arrangement value as a reference.

### [Shift Amount Calculating Process]

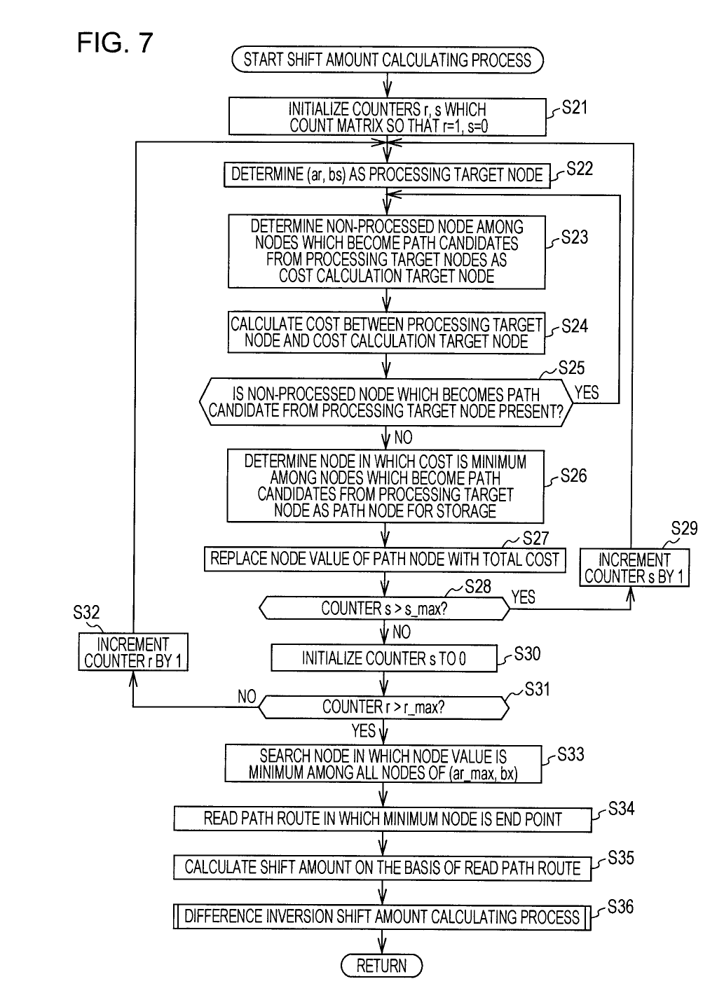

Here, a shift amount calculating process will be described with reference to a flowchart in FIG. 7. In the flowchart in FIG. 7, a shift amount calculating process based on dynamic programming is described as an example, but other techniques may be used.

In step S21, the matching section 22 controls the cost calculating section 22b and initializes a counter r which counts nodes to 1 and a counter s which counts the nodes to 0.

In step S22, the cost calculating section 22b determines a node PD(ar, bs) as a processing target node.

In step S23, the cost calculating section 22b determines a non-processed node among nodes which become path candidates from the processing target nodes as a cost calculation target node.

In step S24, the cost calculating section 22b calculates a cost between the processing target node and the cost calculation target node. The cost is calculated by the positional relationship between the processing target node and the cost calculation target node, and the sum of the respective node values.

In step S25, the cost calculating section 22b determines whether the non-processed node is present among the nodes of the path candidates, and if there is a non-processed node, the procedure returns to step S23. That is, the operations of step S23 to S25 are repeated until costs between the processing target node and all the cost calculation target nodes are calculated.

Further, in step S25, if it is determined that there is no node which becomes the non-processed path candidate, that is, if the costs between the processing target node and all the cost calculation target nodes are calculated, the procedure goes to step S26.

In step S26, the cost calculating section 22b determines a node which corresponds to the minimum cost among the costs between the processing target node and all the cost calculation target nodes as a path node for the processing target node, and stores the result in the path map storing section 22c.

In step S27, the cost calculating section 22b adds a node value of the path node to a node value of the processing target node to calculate the total cost, and uses the result as the node value of the path node.

In step S28, the cost calculating section 22b determines whether the counter s is larger than a maximum value s_max. If the counter s is not larger than a maximum value s_max, the procedure goes to step S29. Then, the counter s is incremented by 1, and the procedure returns to step S22. That is, with respect to all of b0 to b7 in the one-dimensional arrangement value SL, the operations of step S22 to S29 are repeated until the path node is calculated.

Further, in step S29, if it is determined that the counter s is larger than the maximum value s_max, that is, if the path node is calculated with respect to all of b0 to b7 in the one-dimensional arrangement value SL, the cost calculating section 22b initializes the counter s to 0 in step S30.

In step S31, it is determined whether the counter r is larger than a maximum value r_max. For example, if the counter r is not larger than the maximum value r_max, the cost calculating section 22b increments the counter r by 1 in step S32, and the procedure returns to step S22. That is, with respect to all the one-dimensional arrangement values SL and SR, the operations of step S22 to S32 are repeated until the path node is calculated.

Further, if it is determined in step S32 that the counter r is larger than the maximum value r_max, that is, if the path node is calculated with respect to all the one-dimensional arrangement values SL and SR, the procedure goes to step S33.

Here, the “path” refers to, when any one one-dimensional arrangement value among respective one-dimensional arrangement values of two images which form the stereoscopic image is used as a reference, for example, when matching the other one-dimensional arrangement value with the one-dimensional arrangement value which is the reference, a trace indicating movement of each element of the one-dimensional arrangement value. Further, the “cost” relating to the path refers to an index of likelihood when movement between nodes defined by the path is present, in which the likelihood becomes high as the cost becomes small, and the likelihood becomes low as the cost becomes large. Since it is considered that the respective one-dimensional arrangement values of two images are one-dimensional arrangement values in which when any one of the one-dimensional arrangement values is used as a reference, the other one-dimensional arrangement value is enlarged or reduced compared with the one-dimensional arrangement value which is the reference, it is considered that each value of the one-dimensional arrangement value moves according to enlargement or reduction of the one-dimensional arrangement value. Further, it is considered that the order in the one-dimensional arrangement value is not changed before and after the movement. Thus, for example, in the difference absolute value map PD in FIG. 6, the cost calculation target node is set to a node adjacent to the left side of the processing target node, but is not set to a node adjacent to the upper side of the processing target node.

That is, for example, in the case of FIG. 6, when the processing target node is a node PD(a2, b2) (node value is 2), the cost calculation target node becomes nodes PD(a1, b0), PD(a1, b1) and PD(a1, b2).

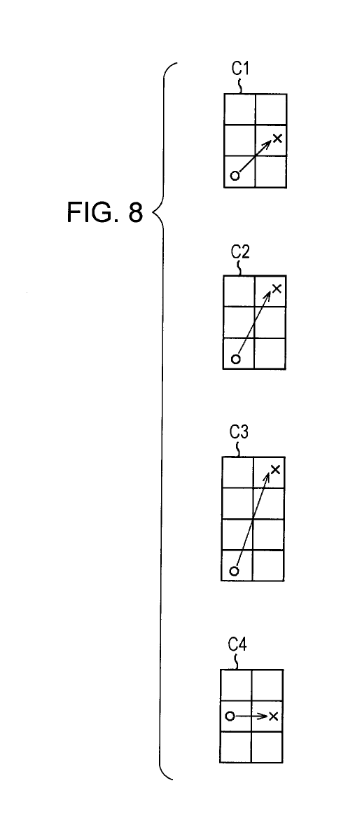

The cost refers to the sum of a path cost and a node cost. That is, the path cost is determined on the basis of the positional relationship between the processing target node and the cost calculation target node PD. For example, as shown in a positional relationship C1 of FIG. 8, when a cost calculation target node including a mark “o” is adjacent to be inclined with respect to a processing target node including a mark “x”, the path cost becomes P×0 (P is an integer). Further, as shown in a positional relationship C2 of FIG. 8, when a cost calculation target node including a mark “o” is separated across one line to be inclined with respect to a processing target node including a mark “x”, the path cost becomes P×1 (P is an integer). Further, as shown in a positional relationship C3 of FIG. 8, when a cost calculation target node including a mark “o” is separated across two lines to be inclined with respect to a processing target node including a mark “x”, the path cost becomes P×2 (P is an integer). Further, as shown in a positional relationship C4 of FIG. 8, when a cost calculation target node including a mark “o” is horizontally adjacent to a processing target node including a mark “x”, the path cost becomes Q (Q is an integer).

Further, the path cost is the node value itself, and is the sum of node values of the processing target node and the cost calculation target node.

Accordingly, for example, in the case of P=Q=2, when the cost calculation target node is PD(a1, b0) with respect to the processing target node PD(a2, b2) in FIG. 6, the path cost is 2, and the node cost is 8 (=2+6). Accordingly, a cost between the processing target node PD(a2, b2) and the cost calculation target node PD(a1, b0) becomes 10 (=8+2). Further, when the cost calculation target node is PD(a1, b1) with respect to the processing target node PD(a2, b2) in FIG. 6, the path cost is 0, and the node cost is 8 (=2+6). Accordingly, a cost between the processing target node PD(a2, b2) and the cost calculation target node PD(a1, b1) becomes 8 (=0+8). Further, when the cost calculation target node is PD(a1, b2) with respect to the processing target node PD(a2, b2) in FIG. 6, the path cost is 2, the node cost is 4 (=2+2). Accordingly, a cost between the processing target node PD(a2, b2) and the cost calculation target node PD(a1, b2) becomes 6 (=4+2).

As a result, the processing target node having the minimum cost among the cost calculating target nodes PD(a1, b0), PD(a1, b1) and PD(a1, b2) with respect to the node PD(a2, b2) is the node PD(a1, b2). Thus, a path is set between the node PD(a2, b2) and the node PD(a1, b2). At this time, the node value of the node PD(a2, b2) is replaced with 6 which is the total cost calculated from 2.

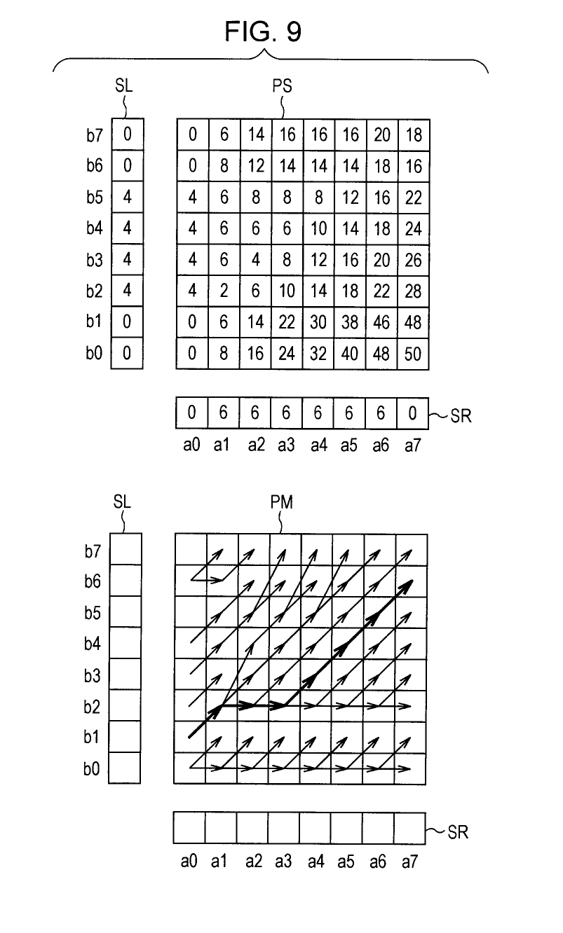

For example, as the operations of steps S22 to S32 are repeated for the difference absolute value map PD in FIG. 6, in the case of P=Q=2, the difference absolute value map PD generated by the difference absolute value map generating section 22a is converted into a difference absolute value map PS as shown in the upper section of FIG. 9. Further, at the same time, a path map PM as shown in the lower section of FIG. 9 is stored in the path map storing section 22c. An arrow in the path map PM in the lower section of FIG. 9 indicates a set path.

In step S33, the shift amount calculating section 22d searches a node of which the node value is the minimum among all node values of the node PS(ar_max, bx) (x=0 to 7) in the difference absolute value map PS stored in the difference absolute value map generating section 22a. That is, the node values of the nodes PS(ar_max, bx) in the difference absolute value map PS in the upper section of FIG. 9 are (50, 48, 28, 26, 24, 22, 16, 18) from the bottom in the figure. Thus, the shift amount calculating section 22d searches a second node from the top which has a node value of 16 which is the minimum among the nodes in the right column of the difference absolute value map PS in the upper section of FIG. 9.

In step S34, the shift amount calculating section 22d sequentially returns to nodes which use the path as a start point from the node of which the node value is the minimum, from the path map stored in the path map storing section 22c, to thereby detect a path route.

That is, for example, in the case of the path map PM shown in the lower section of FIG. 9, as described above, the node having the minimum node value is the node PS(a7, b6) of which the node value is 16, in the difference absolute value map PS shown in the upper section of FIG. 9. Thus, the shift amount calculating section 22d confirms the path set in the node PS(a7, b6). As shown in the lower section of FIG. 9, the path of the node PS(a7, b6) is set in a node PS(a6, b5). Then, the shift amount calculating section 22d confirms the path set in the node PS(a6, b5). As shown in the lower section of FIG. 9, the path of the node PS(a6, b5) is set in a node PS(a5, b4).

Similarly, the shift amount calculating section 22d confirms the path set in the node PS(a5, b4). As shown in the lower section of FIG. 9, the path of the node PS(a5, b4) is set in a node PS(a4, b3). Thus, the shift amount calculating section 22d confirms the path set in the node PS(a4, b3). As shown in the lower section of FIG. 9, the path of the node PS(a4, b3) is set in a node PS(a3, b2). Further, the shift amount calculating section 22d confirms the path set in the node PS(a3, b2). As shown in the lower section of FIG. 9, the path of the node PS(a3, b2) is set in a node PS(a2, b2). Further, the shift amount calculating section 22d confirms the path set in the node PS(a2, b2). As shown in the lower section of FIG. 9, the path of the node PS(a2, b2) is set in the node PS(a1, b2). The shift amount calculating section 22d confirms the path set in the node PS(a1, b2). As shown in the lower section of FIG. 9, the path of the node PS(a1, b2) is set to the node PS(a0, b1).

As a result, the shift amount calculating section 22d detects the nodes PS(a0, b1), PS(a1, b2), PS(a2, b2), PS(a3, b2), PS(a4, b3), PS(a5, b4), PS(a6, b5) and PS(a7, b6) as a path route, as indicated by the thick arrows in the path map PM in FIG. 9.

In step S35, the shift amount calculating section 22d calculates a shift amount on the basis of the read path route, and supplies the result to the imaging magnification control section 23. The shift amount represents that each of the elements a0 to a7 of the one-dimensional arrangement value SR corresponds to an element in a certain position among the values of the respective elements b0 to b7 of the one-dimensional arrangement value SL, and is an amount indicating how many lines the shift is present from the corresponding position which is a reference. Accordingly, in a case where the path route includes the nodes PM(a0, b0), PM(a1, b1), PM(a2, b2), PM(a3, b3), PM(a4, b4), PM(a5, b5), PM(a6, b6) and PM(a7, b7), since all the elements are present in corresponding positions to each other, the shift amounts become (0, 0, 0, 0, 0, 0, 0, 0). The respective elements of the shift amounts (0, 0, 0, 0, 0, 0, 0, 0) are obtained by expressing the shift amounts of the respective elements a0 to a7 of the one-dimensional arrangement value SR with respect to the respective elements b0 to b7 of the one-dimensional arrangement value SL using the number of elements, that is, the number of lines.

Thus, in the case of the path route indicated by the thick arrows on the path map PM shown in the lower section of FIG. 9, since the node PM(a0, b1) which is a start point is shifted by one line in a positive direction with respect to the node PM(a0, b0) which is a reference, the shift amount becomes 1. Further, since the node PM(a1, b2) is shifted by one line in a positive direction with respect to the node PM(a1, b1) which is a reference, the shift amount becomes 1. Since the node PM(a2, b2) is itself the node PM(a2, b2) which is a reference and is not shifted, the shift amount is 0. Further, since the node PM(a3, b2) is shifted by one line in a negative direction with respect to the node PM(a3, b3) which is a reference, the shift amount becomes −1. Similarly, since the nodes PM(a4, b3) to PM(a7, b6) are respectively shifted by one line in a negative direction with respect to the nodes PM(a4, b4) to PM(a7, b7) which are references, the shift amounts become −1. As a result, the shift amounts derived from the path route indicated by the thick arrows in the path map PM shown in the lower section of FIG. 9 become (1, 1, 0, −1, −1, −1, −1, −1).

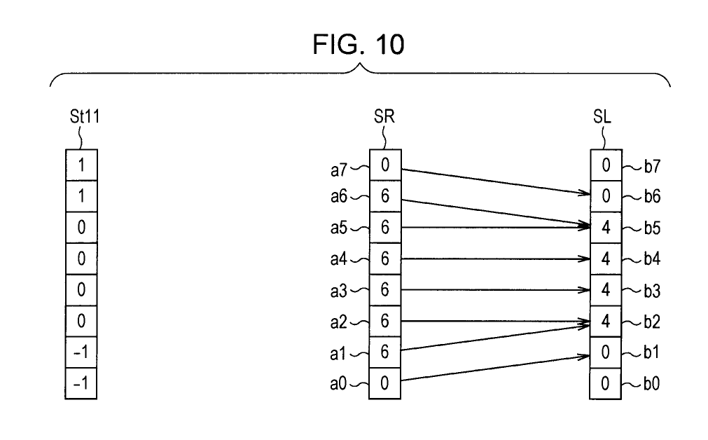

For example, in a case where a0 to a7 of the one-dimensional arrangement value SR are expressed as (0, 6, 6, 6, 6, 6, 6, 0) and b0 to b7 of the one-dimensional arrangement value SL are expressed as (0, 0, 4, 4, 4, 4, 0, 0) in the right section of FIG. 10, the shift amounts become shift amounts St (−1, −1, 0, 0, 0, 0, 1, 1) as shown in the left section of FIG. 10. That is, the shift amounts form a one-dimensional arrangement value including a value indicating a shift direction and a shift amount of each element when the one-dimensional arrangement value SR is matched with the one-dimensional arrangement value SL.

In step S36, the matching section 22 performs a difference inversion shift amount calculating process, and calculates a shift amount by exchanging the one-dimensional arrangement values SR and SL by the same operations as the operations of the steps S21 to S35 described above. With respect to the difference inversion shift amount calculating process, since the one-dimensional arrangement values SR and SL are only exchanged by transposing the difference absolute value maps, and the other operations are the same as in the steps S21 to S35, its description will be omitted. The shift amount calculating process of calculating the shift amount for matching the two one-dimensional arrangement values on the basis of the above-described cost refers to a process of applying, to one-dimensional arrangement values, a so-called elastic matching process in which the shape of a two-dimensional image which is a target is transformed with reference to the shape of a two-dimensional image which is a reference to be matched and coincide with the shape of the two-dimensional image which is the reference.

The total two types of shift amounts are calculated from two images which form the stereoscopic image by the above-described process, with reference to the respective two images.

Returning to the flowchart in FIG. 2, after two types of shift amounts are calculated from two images which form the stereoscopic image, with reference to the respective two images, by the operation of step S4, the procedure goes to step S5.

In step S5, the imaging magnification control section 23 controls the inclination calculating section 23a and calculates an inclination of a shift amount corresponding to each element in a line unit, on the basis of information about two types of shift amounts. At this time, the inclination calculating section 23a divides a difference between the maximum value of the shift amount and the minimum value thereof by the number of pixels to calculate the inclination, or calculates the inclination by the least square method.

Here, the relationship between the one-dimensional arrangement value and the shift amount calculated for each of two images which form the stereoscopic image will be described.

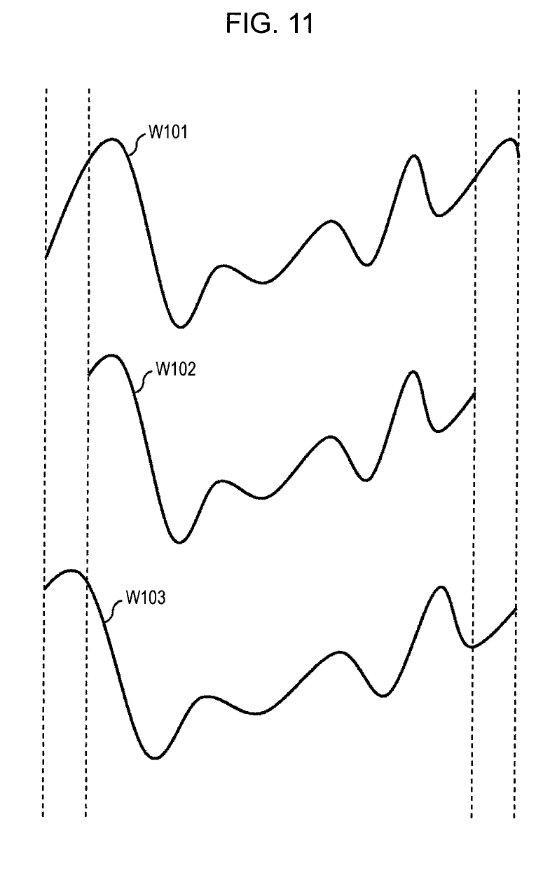

For example, a waveform of the one-dimensional arrangement value of one image which is a reference among two images which form the stereoscopic image is expressed as a waveform W101 shown in the upper section of FIG. 11. In FIG. 11, the horizontal axis represents a line number of each pixel array in the image, and the vertical axis represents a value of an element corresponding to each line which forms the one-dimensional arrangement value. Further, in the one-dimensional arrangement value, the respective elements corresponding to the line numbers are expressed as discrete variation, but in the waveform in FIG. 11, the values thereof are approximately expressed as a curve.

Further, for example, the other image has a zoom magnification higher than that of the reference image, has the same central position as in the reference image, and is formed by an image having a size of 80% of the reference image in its periphery. In this case, the waveform of the one-dimensional arrangement value of the other image is a waveform W103 obtained by extending a waveform W102 shown in the middle section of FIG. 11, in which 10% portions of opposite ends of the waveform W101 are cut, as shown in the lower section of FIG. 11.

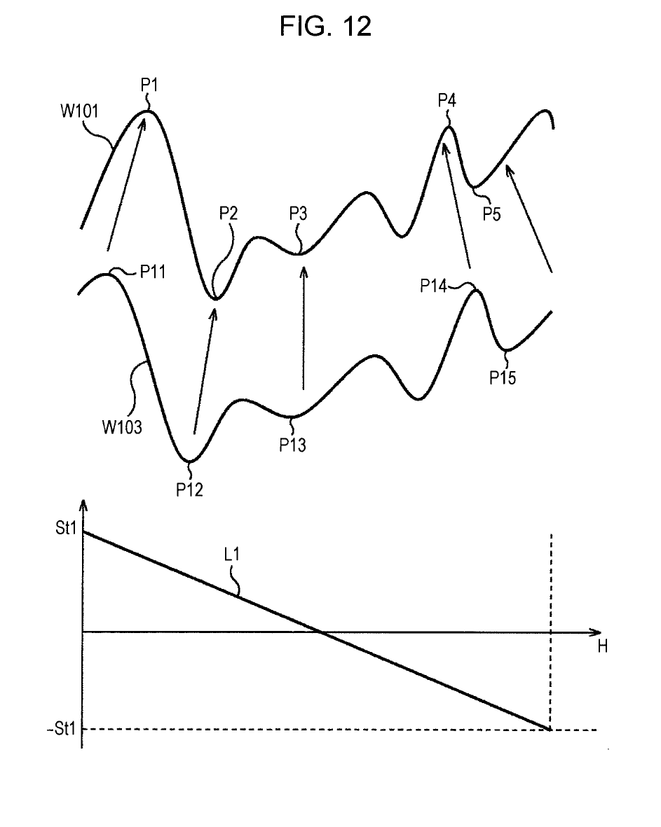

Accordingly, in order to correct the other image among the two images which form the stereoscopic image into the same image as the one image which is a reference, as shown in the upper section of FIG. 12, it is necessary to correct the waveform W103 of the one-dimensional arrangement value of each image to be matched with the waveform W101. That is, by performing correction so that pixels corresponding to line numbers of extreme values P11 to P15 in the waveform W103 are respectively shifted to pixels having the same line numbers of corresponding extreme values P1 to P5 in the waveform W101, the other image can become an image having the same zoom magnification as in the one image.

The relationship between each line number and the shift amount at that time is indicated by a straight line in the lower section of FIG. 12. In the lower section of FIG. 12, the horizontal axis represents each line number of pixels of the other image, and the vertical axis represents a shift amount in one image, to be shifted for the line number in the other image. That is, since a line number “0” of an end part of the waveform W103 of the other image is in a position where the 10% portion is cut from the start point of the waveform W101, if the number of horizontal pixels is a pixel number H, the shift amount corresponds to a pixel of a line number St1 corresponding to 10% thereof (=H/10). Further, since a line number “H” of an end part of the waveform W103 of the other image is in a position where the 10% portion is cut from the end point of the waveform W101, if the number of horizontal pixels is the pixel number H, the shift amount corresponds to a pixel of a line number −St1 corresponding to 10% thereof (=−H/10). As a result, it is possible to express the pixels of the respective line numbers by a straight line L1 connecting the respective shift amounts of the start point and the end point.

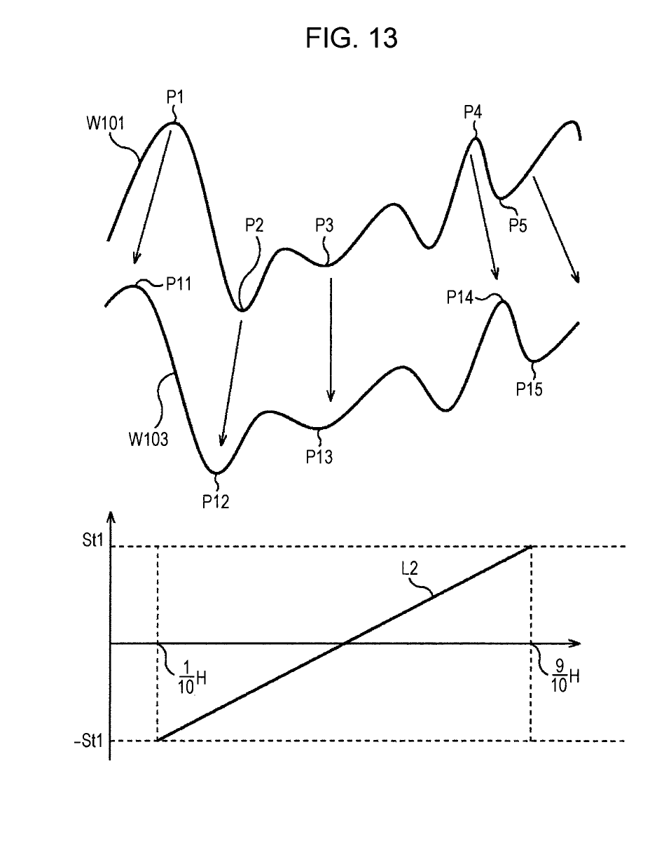

The inclination calculating section 23a calculates an inclination of the straight line L1 as an inclination of the shift amounts of the respective pixels of the waveform W103 when the image of the one-dimensional arrangement value expressed by the waveform W101 is used as a reference. Further, the inclination calculating section 23a calculates the shift amount of each pixel of the waveform W101 as an inclination in the same manner, when the image of the one-dimensional arrangement value expressed by the waveform W103 is used as a reference, as shown in FIG. 13.

That is, in FIG. 13, in a case where the pixels of the image of the one-dimensional arrangement value expressed by the waveform W101 are corrected with reference to the image of the one-dimensional arrangement value expressed by the waveform W103, since the zoom magnification of the image which is the reference is larger, there is no pixel corresponding to a start point of the image to be corrected. Thus, in a position of a line number H/10 which is 10% shorter in horizontal pixel number than the start point of the image to be corrected, the shift amount corresponds to a pixel of −St1 corresponding to 10% of the number of horizontal pixels in a negative direction (−H/10). Similarly, in the case of a pixel having a line number 9H/10 which is 10% shorter in horizontal pixel number than the end point of the image to be corrected, the shift amount corresponds to a pixel of H/10 corresponding to 10% of the number of horizontal pixels in a positive direction. As a result, it is possible to express the pixels of the respective line numbers by a straight line L2 connecting the respective shift amounts of the start point and the end point. That is, the inclination calculating section 23a calculates an inclination of the straight line L2 as an inclination as the shift amounts of the respective pixels of the waveform W101 when the image of the one-dimensional arrangement value expressed by the waveform W103 is used as the reference.

In step S6, the imaging magnification control section 23 controls the reference determining section 23b to determine a reference image and to determine an inclination of a straight line which determines a corresponding shift amount. That is, in a case where the zoom magnification of the reference image is low and the zoom magnification of the image to be corrected is high, as shown in FIG. 12, since the straight line L1 defines the line numbers to be corrected over the entire range, pixels in all the lines can be corrected. On the other hand, in a case where the zoom magnification of the reference image is high and the zoom magnification of the image to be corrected is low, as shown in FIG. 13, since the straight line L2 is not able to define the line numbers to be corrected in the proximity of the start point and the end point thereof, it is difficult to correct the pixels in all the lines. Thus, the reference determining section 23b determines, as the reference image, the image which is capable of defining the line numbers over the entire range and is determined as a negative inclination, among the inclinations of the straight lines L1 and L2 calculated as described with reference to FIGS. 12 and 13.

In step S7, the imaging magnification control section 23 controls the correction amount calculating section 23c to calculate a zoom magnification which is a correction amount, on the basis of the inclination corresponding to the image determined as the reference. That is, in the case of FIGS. 12 and 13, the zoom magnification which is the correction amount is calculated on the basis of the inclination of the straight line L1.

In step S8, the imaging magnification control section 23 performs correction so that one of the correcting sections 24-1 and 24-2 enlarges or reduces the image which is not the reference with the correction amount which is the zoom magnification calculated by the correction amount calculating section 23c.

It is possible to correct deviation of zoom magnifications of two images which form the stereoscopic image, that is, deviation of field angles, by the above-described operations.

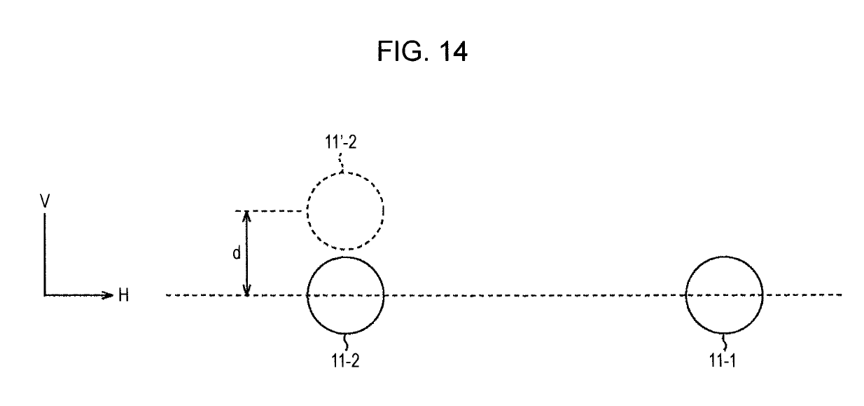

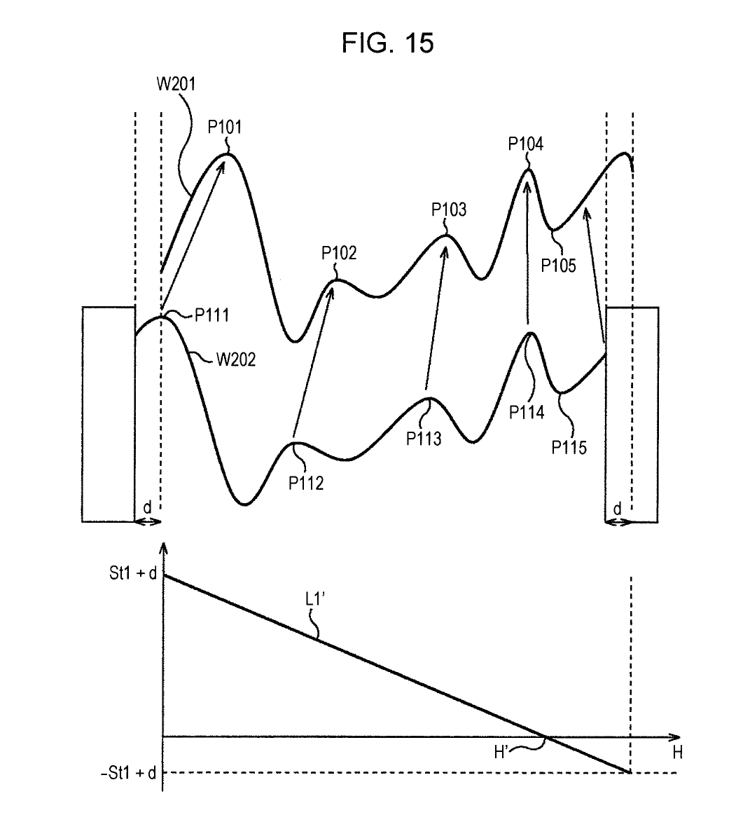

In the above-described example, an example in which the imaging sections 11-1 and 11-2 are set with the same height in the vertical direction is described, but for example, as shown in the imaging sections 11-1 and 11′-2 in FIG. 14, the correction can be performed by the same operations even in a case where their heights are different from each other. That is, in FIG. 14, in a case where the imaging section 11′-2 is deviated by the number of pixels “d” in the vertical direction from the imaging section 11-1, waveforms of the respective one-dimensional arrangement values of the imaging sections 11-1 and 11′-2 have the relationship shown in the upper section of FIG. 15. That is, in the upper section of FIG. 15, a waveform W202 of a one-dimensional arrangement value of an image to be corrected is formed by being deviated from a waveform W201 of a one-dimensional arrangement value of an image which is a reference by the number of pixels “d”. Thus, extreme values P111 to P115 of the waveform W202 of the one-dimensional arrangement value of the image to be corrected correspond to extreme values P101 to P105 of the reference image.

As a result, the shift amounts by the line unit are calculated as a straight line L1′ shown in the lower section of FIG. 15. That is, the shift amount at a start point is St1+d obtained by adding the number of pixels “d” which is the deviation width to the shift amount in the case shown in FIG. 12, and the shift amount at an end point is −St1+d obtained by adding the number of pixels “d” which is the deviation width to the shift amount in the case shown in FIG. 13. Accordingly, the straight line L1 indicating the shift amounts is shifted to the straight line L1′ by the number of pixels “d” which is the deviation width of the imaging section 11′-2.

In other operations, deviation of the zoom magnifications, that is, deviation of field angles are corrected by the same operations as the above-described operations, and the vertical deviation between the imaging sections 11-1 and 11′-2 can be corrected.

### 2. Second Embodiment

### Another Configuration Example of Stereoscopic Image Correcting Apparatus

In the above description, an example in which the optimal path route is calculated in the difference absolute value map by dynamic programming, and then the correction amount is set on the basis of the shift amount calculated from the path route, and the deviation of field angles, that is, the zoom magnification is corrected, has been described. However, in the process of calculating the path route by dynamic programming, since the process of setting the path route is necessary after the costs between the plurality of nodes in the difference absolute value map are calculated, the processing load becomes large.

In this regard, the shift amount is determined according to the size of deviation of the zoom magnifications, and if it is calculated, it is possible to repeatedly use the calculated shift amount. Thus, in a state where the shift amount is calculated according to the size of deviation of the zoom magnifications in advance and the one-dimensional arrangement value is corrected by the shift amount calculated for all the zoom magnifications, the sum of difference absolute values of the respective one-dimensional arrangement values of two images which form the stereoscopic image is calculated. Thus, the image is corrected by the shift amount according to the zoom magnification in which the calculated sum of the difference absolute values is the minimum, and thus, the processing load for calculating the shift amount may be reduced.

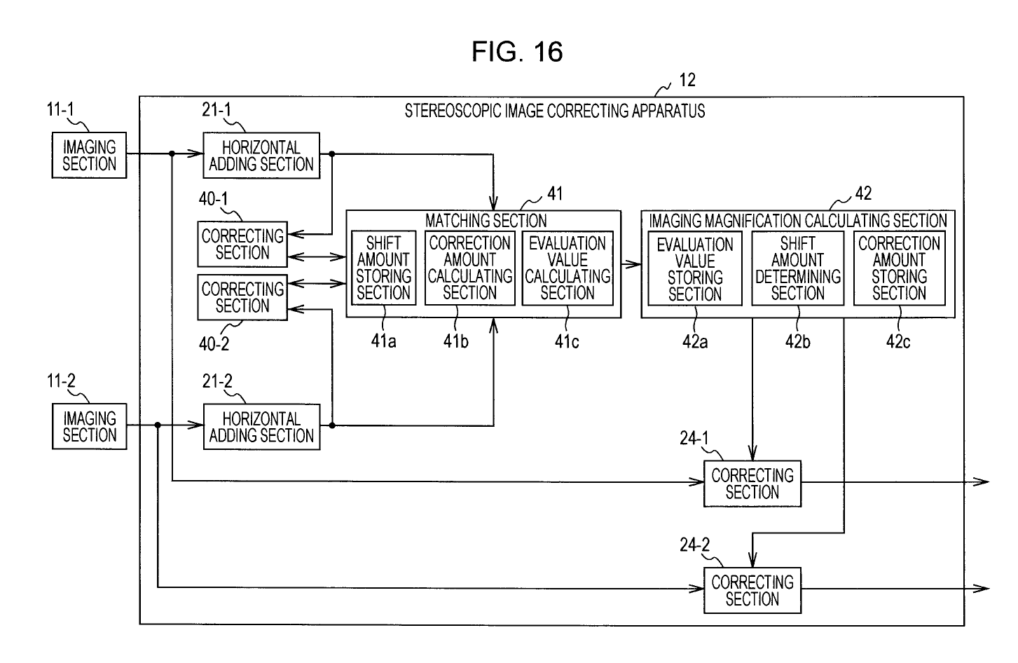

FIG. 16 illustrates a configuration example of a stereoscopic image correcting apparatus 12 which is capable of reducing the processing load for calculating the shift amount. The same names and the same reference numerals are given to the same components as in the stereoscopic image correcting apparatus 12 shown in FIG. 1, and description thereof will be appropriately omitted.

That is, the stereoscopic image correcting apparatus 12 shown in FIG. 16 is different from the stereoscopic image correcting apparatus 12 shown in FIG. 1 in that a matching section 41 and an imaging magnification calculating section 42 are provided instead of the matching section 22 and the imaging magnification control section 23, and correcting sections 40-1 and 40-2 are further provided.

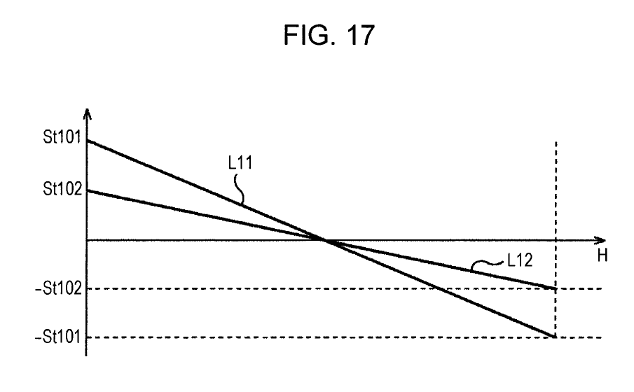

The matching section 41 includes a shift amount storing section 41a, a correction amount calculating section 41b, and an evaluation value calculating section 41c. The matching section 41 sequentially reads the shift amounts set according to deviation of the zoom magnifications which are stored in the shift amount storing section 41a. The shift amount storing section 41a stores the shift amount which is calculated in advance for each zoom magnification deviation by the operations as described with reference to the flowchart of FIG. 7, to correspond to the deviation amount of the zoom magnifications. For example, the shift amount storing section 41a stores information about the shift amounts as indicated by straight lines L11 and L12 in FIG. 17, according to the deviation amount of the zoom magnifications. In FIG. 17, the shift amount of the straight line L11 is St101 at its start point, and is −St101 at its end point. Further, the shift amount of the straight line L12 is St102 (<St101) at its start point, and is −St102 at its end point. For example, in a case where the number of horizontal pixels is H, if deviations of the zoom magnifications of the respective shift amounts L11 and L12 are 20% and 10%, St101 and St102 are respectively H/10 and H/20. Here, it is preferable that the type of the deviation of the zoom magnifications be equal to or larger than two types shown in FIG. 17 and the shift amount be calculated for each of the plurality of deviations of the predetermined magnifications.

The matching section 41 controls the correction amount calculating section 41b to calculate a correction amount of the one-dimensional arrangement value by the shift amount according to all the zoom magnification deviations which are sequentially read. Further, the matching section 41 corrects the one-dimensional arrangement value calculated by the horizontal adding sections 21-1 and 21-2 for the respective correcting sections 40-1 and 40-2, with the correction amount calculated by the correction amount calculating section 41b.

The correcting sections 40-1 and 40-2 supply the corrected one-dimensional arrangement value to the matching section 41. The matching section 41 controls the evaluation value calculating section 41c to calculate the sum of difference absolute values of the one-dimensional arrangement values corrected with the correction amounts based on the shift amounts according to the zoom magnification deviations which are sequentially different, as an evaluation value according to the zoom magnification deviation. The matching section 41 supplies the evaluation value calculated for each size of zoom magnification deviation to the imaging magnification calculating section 42 as an adjustment parameter. At this time, the matching section 41 further supplies information about the correction amount according to the shift amount to the imaging magnification calculating section 42.

The imaging magnification calculating section 42 includes an evaluation value storing section 42a, a shift amount determining section 42b, and a correction amount storing section 42c. The imaging magnification calculating section 42 stores the evaluation value calculated for each size of zoom magnification deviation which is sequentially supplied from the matching section 41 and information about the shift amount, in the evaluation value storing section 42a. The imaging magnification calculating section 42 controls the shift amount determining section 42b to evaluate the evaluation value and to determine which shift amount is to be used. Further, the imaging magnification calculating section 42 stores the zoom magnification according to the shift amount determined by the shift amount determining section 42b in the correction amount storing section 42c as a correction amount, and performs control so that an image of any one of the correcting sections 24-1 and 24-2 is enlarged or reduced according to the zoom magnification which is the correction amount stored in the correction amount storing section 42c.

### [Stereoscopic Image Correcting Process in Stereoscopic Image Correcting Apparatus in FIG. 16]

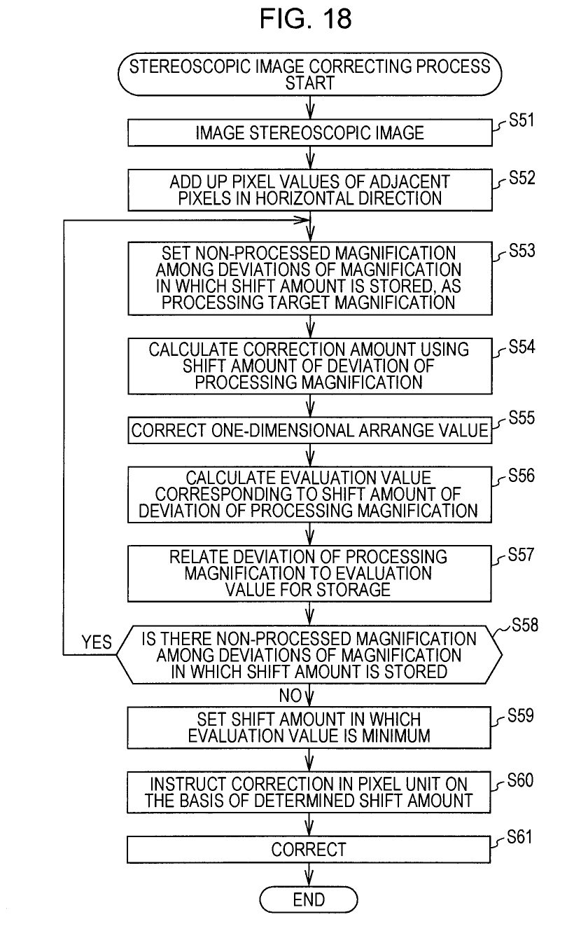

Next, a stereoscopic image correcting process in the stereoscopic image correcting apparatus 12 in FIG. 16 will be described with reference to a flowchart of FIG. 18. Further, since operations of steps S51, S60 and S61 in FIG. 18 are the same as the operations of steps S1, S7 and S8 in FIG. 2, description thereof will be omitted.

That is, images are imaged by the imaging sections 11-1 and 11-2 in step S51, and the procedure goes to step S52.

In step S52, each of the horizontal adding sections 21-1 and 21-2 adds up pixel values of pixels which form the supplied stereoscopic image by the line unit, generates a one-dimensional arrangement value including the added value in each line, and supplies the result to the correcting sections 21-1 and 21-2 and the matching section 41.

In step S53, the matching section 41 sets a shift amount corresponding to zoom magnification deviation which is non-processed, among the shift amounts stored in the shift amount storing section 41a, and among the shift amounts corresponding to the non-processed magnification deviation, as a processing target shift amount.

In step S54, the matching section 41 controls the correction amount calculating section 41b to calculate a correction amount of the one-dimensional arrangement value according to the processing target shift amount.

In step S55, the matching section 41 supplies information about the calculated correction amount to the correcting sections 40-1 and 40-2 to respectively correct the one-dimensional arrangement value calculated by the horizontal adding sections 21-1 and 21-2 and to supply the result to the matching section 41.

In step S56, the matching section 41 controls the evaluation value calculating section 41c to calculate the sum of difference absolute values of the respective elements of two one-dimensional arrangement values as an evaluation value corresponding to the zoom magnification deviation which is a processing target, and supplies the result to the imaging magnification calculating section 42. At this time, the matching section 41 further supplies information about the correction amount corresponding to the zoom magnification deviation which is the processing target to the imaging magnification calculating section 42.

In step S57, the imaging magnification calculating section 42 controls the evaluation value storing section 42a to store the evaluation value and the correction amount information which are supplied, to correspond to the zoom magnification deviation.

In step S58, the matching section 41 determines whether a shift amount which is not set as the shift amount which is the processing target is present among the shift amounts stored in the shift amount storing section 41a. In step S58, for example, if the shift amount which is not set as the shift amount which is the processing target is present, the procedure returns to step S53. That is, the operations of steps S53 to S58 are repeated until the evaluation value is calculated for all the shift amounts. In step S58, if the evaluation value is calculated for all the shift amounts, the procedure goes to step S59.

In step S59, the imaging magnification calculating section 42 controls the shift amount determining section 42b to evaluate the evaluation value and to determine which shift amount is to be used. That is, since the fact that the sum of difference absolute values of the respective elements of the one-dimensional arrangement value which is the evaluation value is the minimum means that deviation of the one-dimensional arrangement values corresponding to two stereoscopic images becomes minimum by correction based on the shift amount corresponding to the zoom magnification deviation, a shift amount at this time is determined as the shift amount to be used.

In step S60, the imaging magnification calculating section 42 stores the zoom magnification which is the correction amount set corresponding to the determined shift amount in the correction amount storing section 42c.

In step S61, the imaging magnification calculating section 42 controls the correcting sections 24-1 and 24-2 with the zoom magnification which is the correction amount stored in the correction amount storing section 42c to enlarge or reduce any image imaged by the imaging sections 11-1 and 11-2, in advance.

With the above operations, when the correction amount to be corrected is determined, it is not necessary to calculate the shift amount by a process such as dynamic programming, to thereby make it possible to reduce the processing load. As a result, it is possible to correct deviation of zoom magnifications of two images for a stereoscopic image, that is, deviation of field angles at high speed. Here, in the stereoscopic image correcting apparatus 12 shown in FIG. 16, deviation of the imaging positions of the imaging sections 11-1 and 11-2 can be corrected in a similar way to the stereoscopic image correcting apparatus 12 shown in FIG. 1. In this case, it is necessary to calculate a shift amount corresponding to deviation of the imaging positions of the imaging sections 11-1 and 11-2.

In the above description, an example in which the images are corrected in the pixel unit to correct the zoom magnification, that is, the field angle has been described, but the images imaged by the imaging sections 11-1 and 11-2 may be adjusted by a device of an optical system to adjust the zoom magnification. Further, a position where each of the imaging sections 11-1 and 11-2 is physically disposed may be moved forward or backward in an imaging direction to adjust the zoom magnification.

According to the embodiments, it is possible to correct deviation of zoom magnifications of two images for a stereoscopic image, that is, deviation of field angles.

Here, the series of processes as described above may be performed by hardware or software. In a case where the series of processes are performed by software, a program which forms the software is installed from a recording medium to a computer which is combined with dedicated hardware, or for example, to a general-purpose personal computer or the like which is capable of causing a variety of functions to be executed by being installed with a variety of programs.

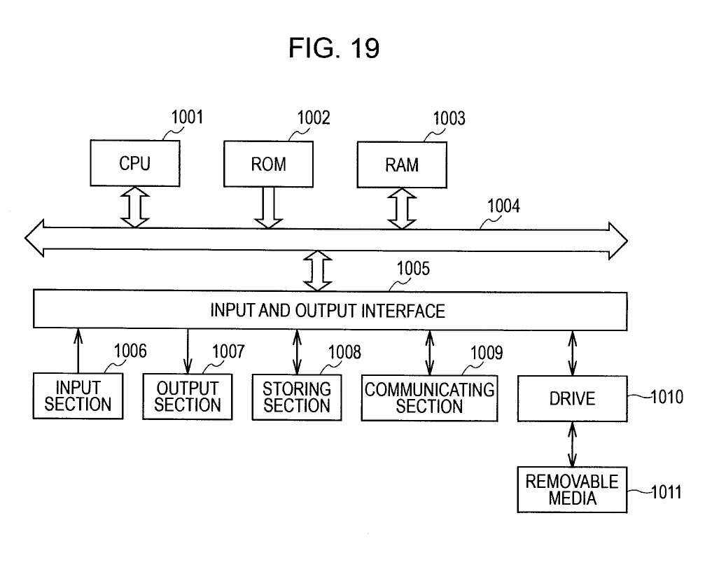

FIG. 19 illustrates a configuration example of a general-purpose personal computer. The personal computer is mounted therein with a CPU (Central Processing Unit) 1001. An input and output interface 1005 is connected to the CPU 1001 through a bus 1004. A ROM (Read Only Memory) 1002 and a RAM (Random Access Memory) 1003 are connected to the bus 1004.

To the input and output interface 1005 are connected an input section 1006 which includes an input device, such as a keyboard or mouse, through which a user inputs an operational command, an output section 1007 which outputs a processing operation screen or an image which is a processing result to a display device, a storing section 1008 which includes a hard disk drive or the like which stores programs or various data, and a communication section 1009 which includes a LAN (Local Area Network) adapter or the like and performs a communication process through a network such as the Internet. Further, to the input and output interface 1005 is connected a drive 1010 which reads or writes data with respect to a removable medium 1011 such as a magnetic disk (including a flexible disk), an optical disc (including a CD-ROM (Compact Disc-Read Only Memory) and a DVD (Digital Versatile Disc)), a magneto-optical disc (including an MD (Mini Disc)), or a semiconductor memory.

The CPU 1001 performs a variety of processes according to a program which is stored in the ROM 1002, or a program which is read from the removable medium 1011 such as a magnetic disk, an optical disc, a magneto-optical disc, or a semiconductor memory, is installed to the storing section 1008, and is loaded to the RAM 1003 from the storing section 1008. The RAM 1003 also stores data or the like necessary for the CPU 1001 to perform the variety of processes.

In the present description, the operation of describing the program stored in the recording medium includes a process which is performed in a time series manner in the disclosed order, or a process which is in parallel or individually performed, not in a time series manner.

The present disclosure contains subject matter related to that disclosed in Japanese Priority Patent Application JP 2010-236156 filed in the Japan Patent Office on Oct. 21, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising:
an imaging section which images a first image and a second image;
a one-dimensional arrangement value calculating section which adds up pixel values of horizontal pixels in respective lines in the first image and the second image to calculate a first one-dimensional arrangement value and a second one-dimensional arrangement value;
an adjustment parameter calculating section which calculates an adjustment parameter based on a difference between the first one-dimensional arrangement value and the second one-dimensional arrangement value; and
a correction control section which controls correction of a magnification of the first image or the second image on the basis of the adjustment parameter.

2. The apparatus according to claim 1,
wherein the adjustment parameter calculating section calculates an adjustment parameter for matching the first one-dimensional arrangement value and the second one-dimensional arrangement value on the basis of the difference between the first one-dimensional arrangement value and the second one-dimensional arrangement value.

3. The apparatus according to claim 2,
wherein the adjustment parameter calculating section includes:
a difference absolute value map generating section which generates a difference absolute value map including an absolute value of the difference between the first one-dimensional arrangement value and the second one-dimensional arrangement value;
a cost calculating section which calculates a cost between respective nodes in the difference absolute value map when a path from one end portion of the difference absolute value map to the other end portion thereof is formed; and
a shift amount calculating section which calculates a shift amount from a path in which the cost calculated by the cost calculating section is the minimum, as the adjustment parameter.

4. The apparatus according to claim 3,
wherein the difference absolute value map generating section generates a first difference absolute value map including a difference absolute value between respective elements of the first one-dimensional arrangement value and the second one-dimensional arrangement value when the respective elements of the first one-dimensional arrangement value are used as a reference, and a second difference absolute value map including a difference absolute value between the respective elements of the first one-dimensional arrangement value and the second one-dimensional arrangement value when the respective elements of the second one-dimensional arrangement value are used as a reference.

5. The apparatus according to claim 4,
wherein the correction control section controls the correction of the magnification of the first image or the second image, on the basis of an inclination of a shift amount in which the inclination is calculated as a negative value, among an inclination of a shift amount based on the first difference absolute value map and an inclination of a shift amount based on the second difference absolute value map.

6. The apparatus according to claim 5,
wherein the correction control section calculates the inclination of the shift amount on the basis of a maximum value or a minimum value of the shift amount which is the adjustment parameter or on the basis of a least square method, and controls the correction of the magnification of the first image or the second image on the basis of the inclination.

7. The apparatus according to claim 3,
wherein the cost calculating section calculates the cost between the respective nodes in the difference absolute value map when the path from one end portion of the difference absolute value map to the other end portion thereof is formed, by dynamic programming.

8. The apparatus according to claim 2,
wherein the adjustment parameter calculating section includes:
a storing section which stores information on the shift amounts according to a plurality of correction amounts for the first one-dimensional arrangement value or the second one-dimensional arrangement value;
a shifting section which shifts the first one-dimensional arrangement value or the second one-dimensional arrangement value on the basis of the shift amount for each correction amount stored in the storing section;
and an evaluation value calculating section which calculates an evaluation value including the sum of the difference absolute values of the respective elements of the first one-dimensional arrangement value and the second one-dimensional arrangement value shifted by the shifting section as the adjustment parameter, and
wherein the correction control section includes a correction amount determining section which determines a correction amount in which the evaluation value which is the adjustment parameter is the minimum, and controls the correction of the magnification of the first image or the second image with the correction amount determined by the correction amount determining section.

9. An image processing method in an image processing apparatus including an imaging section which images a first image and a second image; a one-dimensional arrangement value calculating section which adds up pixel values of horizontal pixels in respective lines in the first image and the second image to calculate a first one-dimensional arrangement value and a second one-dimensional arrangement value; an adjustment parameter calculating section which calculates an adjustment parameter based on a difference between the first one-dimensional arrangement value and the second one-dimensional arrangement value; and a correction control section which controls correction of a magnification of the first image or the second image on the basis of the adjustment parameter, the method comprising:
imaging the first image and the second image, by the imaging section;
adding up the pixel values of the horizontal pixels in the respective lines in the first image and the second image to calculate the first one-dimensional arrangement value and the second one-dimensional arrangement value, by the one-dimensional arrangement value calculating section;
calculating the adjustment parameter based on the difference between the first one-dimensional arrangement value and the second one-dimensional arrangement value, by the adjustment parameter calculating section; and
controlling the correction of the magnification of the first image or the second image on the basis of the adjustment parameter, by the correction control section.

10. A program which causes a computer which controls an image processing apparatus including an imaging section which images a first image and a second image; a one-dimensional arrangement value calculating section which adds up pixel values of horizontal pixels in respective lines in the first image and the second image to calculate a first one-dimensional arrangement value and a second one-dimensional arrangement value; an adjustment parameter calculating section which calculates an adjustment parameter based on a difference between the first one-dimensional arrangement value and the second one-dimensional arrangement value; and a correction control section which controls correction of a magnification of the first image or the second image on the basis of the adjustment parameter, to execute a routine comprising:
imaging the first image and the second image, by the imaging section;
adding up the pixel values of the horizontal pixels in the respective lines in the first image and the second image to calculate the first one-dimensional arrangement value and the second one-dimensional arrangement value, by the one-dimensional arrangement value calculating section;
calculating the adjustment parameter based on the difference between the first one-dimensional arrangement value and the second one-dimensional arrangement value, by the adjustment parameter calculating section; and
controlling the correction of the magnification of the first image or the second image on the basis of the adjustment parameter, by the correction control section.
